(19) United States
(12) Patent Application Publication
(10) Pub. No.: US 2025/0362840 A1
(43) Pub. Date: Nov. 27, 2025

(54) DISPLAY CONTROL METHOD, AND DISPLAY CONTROL SYSTEM

(71) Applicant: CANON KABUSHIKI KAISHA, Tokyo (JP)

(72) Inventor: YUMI IKARASHI, Kanagawa (JP)

(21) Appl. No.: 19/211,475

(22) Filed: May 19, 2025

(30) Foreign Application Priority Data
May 23, 2024 (JP) 2024-084295

(51) Int. Cl. G06F 3/12; G06F 3/14

(52) U.S. Cl. CPC G06F 3/121; G06F 3/1253; G06F 3/1438; G06F 3/1454; G06F 3/1287

(57) ABSTRACT

A display control method for controlling display contents on a display device capable of displaying a screen related to an apparatus, includes: displaying a screen of a function using a first function control unit in the apparatus on a second display device operated by a second user different from a first user operating a first display device, based on an instruction from the second user; and performing control so that a screen related to the apparatus displayed on the second display device is not transitioned to a screen related to the apparatus displayed on the first display device, in a case where a screen of a function that uses a second function control unit different from the first function control unit in the apparatus and requires ensuring safety is operated on the first display device, based on an instruction from the first user.

### BACKGROUND OF THE INVENTION

### Field of the Invention

The present disclosure relates to a display control method, and a display control system.

### Description of the Related Art

In an apparatus having plural functions, plural display interface units that can be connected to one apparatus can individually use the plural functions of this one apparatus. In such an apparatus, the plural of functions are operated simultaneously through different display interfaces so that different users can operate the plural of functions according to their own purposes.

Japanese Patent Laid-Open No. 2021-028136 (hereinafter referred to as Document 1) discloses a technology to enable flexible switching of display contents according to functions by classifying the display contents on a screen of a non-executor into categories and referring to the correspondence between the state of an apparatus during the execution of a function and the category. In a case where plural users simultaneously use the apparatus through their respective display interfaces, the types of display devices are assumed to be a UI directly connected to a main controller and a remote UI installed remotely. As described in ISO 12643-1:2009, “6.5.3 Remote control with interlocking guard open, 2009”, in a case of remote operation using the remote UI, the apparatus safety regulations stipulate that control cannot be started unless the safety of the apparatus is ensured.

### SUMMARY OF THE INVENTION

A display control method according to the present disclosure for controlling display contents on a display device capable of displaying a screen related to an apparatus, includes: displaying a screen of a function using a first function control unit in the apparatus on a second display device operated by a second user different from a first user operating a first display device, based on an instruction from the second user; and performing control so that a screen related to the apparatus displayed on the second display device is not transitioned to a screen related to the apparatus displayed on the first display device, in a case where a screen of a function that uses a second function control unit different from the first function control unit in the apparatus and requires ensuring safety is operated on the first display device, based on an instruction from the first user.

Further features of the present disclosure will become apparent from the following description of exemplary embodiments with reference to the attached drawings.

### BRIEF DESCRIPTION OF THE DRAWINGS

FIG. 1 is a schematic diagram of a printing system;

FIG. 2 is a block diagram of a control system of the printing system;

FIG. 3 is a function classification list based on whether to perform a screen operation on a display device and whether to open a door;

FIG. 4 is a flowchart related to UI display contents on the display device;

FIG. 5 is a category list of display switching;

FIG. 6 is a correspondence list between apparatus states and categories;

FIG. 7 is a diagram showing a specific example of category A;

FIG. 8 is a diagram showing a specific example of category B;

FIG. 9 is a diagram showing a specific example of category C;

FIG. 10 is a diagram showing a specific example of category D;

FIG. 11A is a diagram showing an example of a display layout of a non-executor screen;

FIG. 11B is a diagram showing an example of the display layout of the non-executor screen;

FIG. 11C is a diagram showing an example of the display layout of the non-executor screen;

FIG. 12 is a diagram showing an example of UI display switching for an executor and a non-executor;

FIG. 13 is a flowchart related to UI display contents on the display device;

FIG. 14 is a correspondence list between the apparatus states and categories in a case where the executor is a main body UI user;

FIG. 15 is a correspondence list between the apparatus states and categories in a case where the executor is a remote UI user;

FIG. 16 is an image diagram showing a positional relationship between the apparatus and the user;

FIG. 17 is a correspondence list between the apparatus states and the categories based on the user's position from the apparatus;

FIG. 18 is a correspondence list between the apparatus states and the categories based on the executor's position from the apparatus; and

FIG. 19 is a diagram showing an example of user information.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. In addition, the same components are denoted by the same reference numerals. Further, each process (step) in the flowcharts and the sequence charts is denoted by a reference numeral starting with S.

### First Embodiment

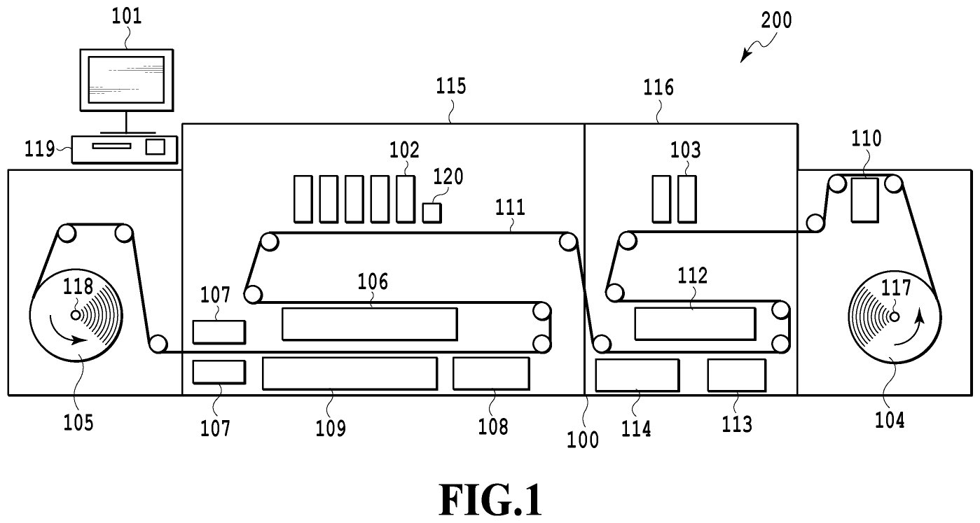

A configuration of a printing system according to the present embodiment will be described. FIG. 1 shows an example of a schematic configuration of a printing system 100 according to the present embodiment. The printing system 100 is an apparatus for forming images on a continuous print medium 111 (hereinafter referred to as “roll paper”) used in the present embodiment on which images can be continuously formed. In the present embodiment, the printing system 100 includes a paper feeder 104 that feeds the roll paper 111, and a printing unit 116 that performs particular color printing. The printing system 100 also includes a printing unit 115 that performs basic color printing, a winding device 105 that winds the roll paper 111, and a user interface operation panel 101 (hereinafter referred to as “UI operation panel”).

The paper feeder 104 is a device that supplies the roll paper 111 to the printing system 100. The paper feeder 104 rotates the paper tube of the roll paper 111 around a rotating shaft 117 to convey the roll paper 111 wound around the paper tube toward the printing system 100 at a constant speed via plural rollers (conveyance rollers, feed rollers, and the like). The winding device 105 is a device that winds the roll paper 111 conveyed from the printing system 100 into a roll around the paper tube. The paper tube is attached to a rotating shaft 118. The winding device 105 rotates the paper tube around the rotating shaft 118 to wind the roll paper 111 conveyed to the paper tube via plural rollers (for example, conveyance rollers, discharge rollers, and the like) as a print product at a predetermined speed. The print product is wound around the paper tube and held in a roll shape.

As an operation before printing starts, the paper feeder 104 feeds the roll paper 111 to the winding device 105. The roll paper 111 is set in the paper feeder 104, and the leading edge of the roll paper 111 passes above a skew correction device 110. The roll paper 111 then passes under a printing device 103 of the printing unit 116. The printing device 103 according to the present embodiment is a device that performs printing using a white ink or the like, for example, other than color inks, cyan (C), magenta (M), yellow (Y), and black (K). The roll paper 111 is then fed under a drying device 112 and above cooling devices 113 and 114. Thereafter, the roll paper 111 passes under a mark detection sensor 120 and a printing device 102 of the printing unit 115, and passes under a drying device 106 and above cooling devices 108 and 109. In the present embodiment, the mark detection sensor 120 is used for alignment during image formation by the printing device 102 on an image formed by the printing device 103. However, the present disclosure is not limited thereto, and a scanner device may be used, for example. The printing device 102 according to the present embodiment is a device that performs printing using basic colors (CMYK) for printing. The roll paper 111 is wound around the winding device 105 through a connected scanner device 107. After the roll paper 111 is fed into the printing system 100, a print job is submitted to a control PC 119 of the printing system 100. After the print job is submitted, printing starts as a print start button is pressed on the UI operation panel 101. The connected scanner device 107 reads a printed image, and the control PC 119 analyzes the read image to check whether there are any defects in the printed matter.

The printing system 100 is equipped with an interlock function to ensure its safe operation. For example, the printing unit 115 and the printing unit 116 each have a switch on their doors to activate the interlock. The interlock is activated when the door of the printing unit 115 or the printing unit 116 is opened. As the interlock is activated, the conveyance of the roll paper 111, if any, is switched to low-speed conveyance at a speed equal to or lower than a predetermined speed. In a case where the conveyance of the roll paper 111 is stopped, the conveyance of the roll paper 111 is not started until the interlock is disabled.

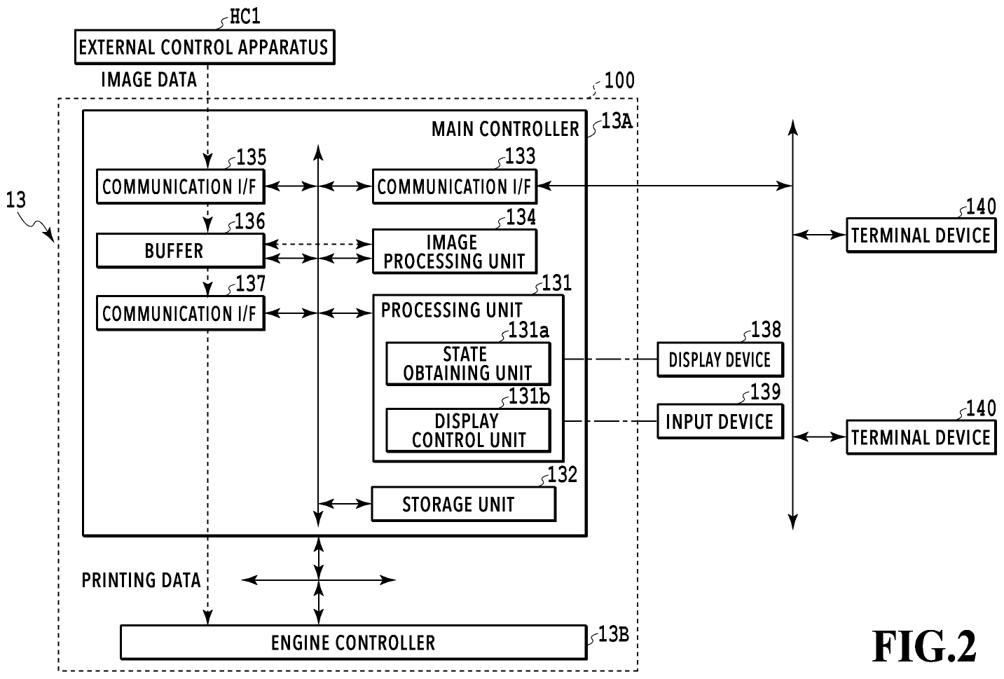

Next, a control unit 13 of the printing system 100 will be described. FIG. 2 is a block diagram of the control unit 13 of the printing system 100. The control unit 13 is communicatively connected to an external control apparatus HC1 (for example, a personal computer). A printing application required for printing is installed in the external control apparatus HC1.

The external control apparatus HC1 generates and saves image data that is the source of an image to be printed. The image data here is generated in an electronic file format such as a document file or an image file, for example. This image data is transmitted to the control unit 13 from the external control apparatus HC1. The control unit 13 starts image processing and printing operations based on the image data thus received.

In the present embodiment, the control unit 13 is broadly divided into a main controller 13A and an engine controller 13B. The main controller 13A includes a processing unit 131, a storage unit 132, a communication interface (I/F) 133, an image processing unit 134, a communication I/F 135, a buffer 136, and a communication I/F 137. The main controller 13A is also connected to a display device 138 and an input device 139.

The processing unit 131 is a processor such as a CPU, which executes a program stored in the storage unit 132 to control the entire main controller 13A. The storage unit 132 is a storage device such as a RAM, a ROM, a hard disk, or a solid state drive (SSD), which stores programs and data executed by the CPU and provides a work area for the CPU. The processing unit 131, which performs overall control, includes a state obtaining unit 131a that obtains the state of the apparatus and a display control unit 131b that controls the contents displayed by the display device 138. The display device 138 is a display device such as a touch panel, a liquid crystal display, or a tablet. The UI operation panel 101 also corresponds to the display device 138. The input device 139 is an input device such as a keyboard and a mouse to receive user instructions. The display device 138 and the input device 139 are separate in the present embodiment, but the present disclosure is not limited thereto. The display device 138 and the input device 139 may be integrated using the touch panel or tablet described above. The communication I/F 133 communicates with another terminal device 140. The terminal device 140 includes a display device equivalent to the display device 138, which serves as a UI to display the display contents controlled by the display control unit 131b.

The image processing unit 134 is an electronic circuit with an image processing processor, for example. The buffer 136 is, for example, a RAM, a hard disk, or an SSD. The communication I/F 135 communicates with the external control apparatus HC1, and the communication I/F 137 communicates with the engine controller 13B. In FIG. 2, the dashed arrows indicate an example of the flow of image data processing. The image data received from the external control apparatus HC1 through the communication I/F 135 is accumulated in the buffer 136. The image processing unit 134 reads the image data from the buffer 136 and performs predetermined image processing on the read image data before storing it again in the buffer 136. The image data after the image processing stored in the buffer 136 is transmitted to the engine controller 13B from the communication I/F 137 as printing data to be used by a print engine. The engine controller 13B causes the printing unit 116 and the printing unit 115 to perform printing on the roll paper 111 conveyed by the plural rollers from the paper feeder 104, and then conveys the roll paper 111 to the winding device 105.

The engine controller 13B also controls the interlock function. For example, the engine controller 13B activates the switch to activate the interlock in a case where the door of the printing unit 115 or the printing unit 116 is opened. As the interlock is activated, the conveyance of the roll paper 111, if any, is switched to low-speed conveyance at a speed equal to or lower than a predetermined speed. In a case where the conveyance of the roll paper 111 is stopped, the engine controller 13B controls the conveyance of the roll paper 111 not to be started until the interlock is disabled.

### DETAILED DESCRIPTION OF PRESENT EMBODIMENT

As shown in FIG. 2, in the display control system of the present embodiment, in a case where there is more than one display device for one apparatus, plural users can use each display device. As an example of such a configuration, if a web server is started on the main controller, the UI of the apparatus can be displayed on each display device using a browser via a network. In this case, the same information can be displayed on the UIs of all display devices. It is also possible to display different information on the UI of each display device. Since more than one browser can be started on one display device, plural users or a single user can use one display device with more than one UI displayed. In a case where a client program used to display the browser in each display device is configured to periodically obtain information from the server, the display information can be updated at any time without user operation. Alternatively, the display information can be updated at any time by adopting a configuration in which the server notifies a client in a case where the information on the apparatus is updated before updating the information.

In a case where a user executes a function that uses either or both of the main controller 13A and the engine controller 13B exclusively for processing from a UI displayed on the display device 138, that user becomes an “executor” of that function. Other users become “non-executors” of that function. Depending on the function, the screen display during execution of a function may need to display the same contents for the executor and non-executor, may need to display different contents for the executor and non-executor, or the like. Here, even if the executor has exclusive use of the main controller 13A, the state obtaining unit 131a and the display control unit 131b that control the display device are not included in the control unit that controls the functions executed by the main controller 13A.

In FIG. 2, there are also plural of display devices. Among these plural display devices, the UI of the display device directly connected to the main controller, such as the display device 138 in FIG. 2, is defined as a main body UI. Unlike the main body UI, the UI of the display device of the terminal device connected to the main controller through the communication I/F 133 is defined as a remote UI. Since the main body UI is often placed near the apparatus, operations using the main body UI may be more urgent or important than operations from the remote UI, which is often placed remotely. In this case, it may be effective to change a correspondence list to be applied depending on whether the main body UI user is the executor or non-executor of the function from the user information.

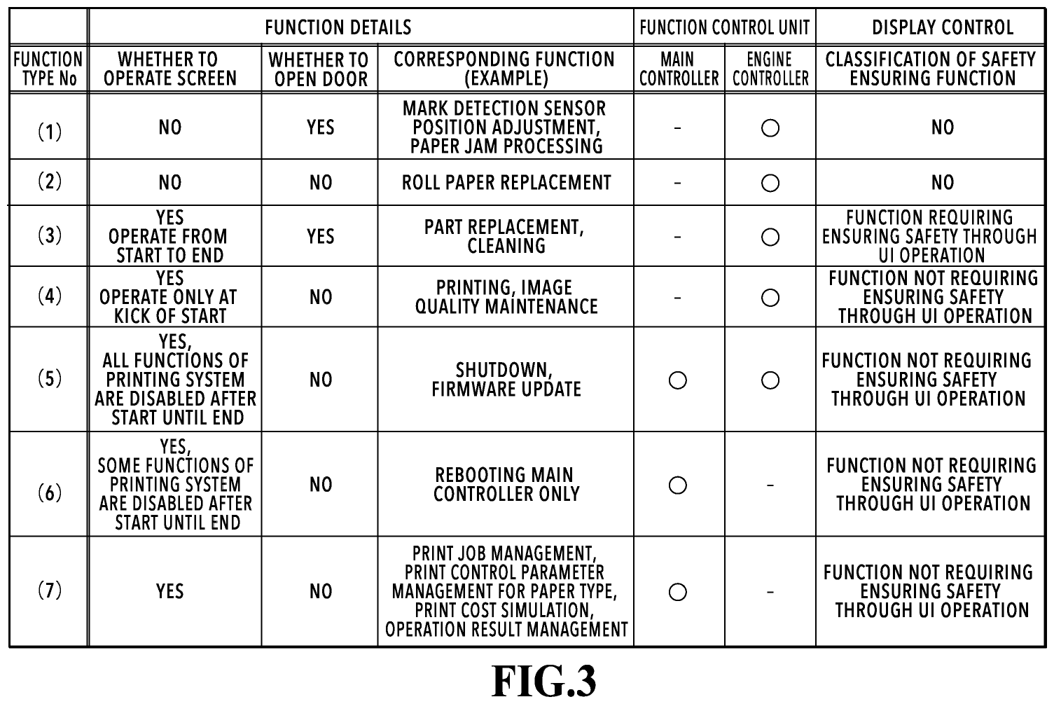

FIG. 3 shows an example of a list in which the functions executed in the printing system 100 are classified by “function type No.” depending on whether to perform a screen operation on the display device and whether to open the door. For each classified “function type No.”, the function control unit mainly used to execute the function, between the main controller 13A and the engine controller 13B, is shown as follows. “o” indicates the function control unit that executes the function, while “-” indicates the function control unit that does not execute the function.

Function type (1) in FIG. 3 corresponds to a function that does not involve any screen operation and involves an operation to open the door on the printing system 100. For example, this includes adjusting the position of the mark detection sensor 120 and jam clearance of a paper jam that occurs in the printing unit 115 or the printing unit 116. The processing for executing the function is mainly controlled by the engine controller 13B. Function type (2) in FIG. 3 is a function that does not involve any screen operation and does not involve the operation to open the door even if the operation involves direct access to the printing system 100. This corresponds, for example, to replacing the roll paper in the paper feeder 104 or the winding device 105. The processing for executing the function is mainly controlled by the engine controller 13B.

Function type (3) in FIG. 3 corresponds to a function that involves a screen operation from the start to the end of the function execution and includes the operation to open the door. All functions that require both screen operation and the operation to open the door correspond to Function type (3) in FIG. 3. This corresponds, for example, to part replacement or cleaning work. The processing for executing the function is mainly controlled by the engine controller 13B. Function type (4) in FIG. 3 corresponds to the following function. This function involves a screen operation only in a case where the function execution is started. In addition, this function is always executed in a state where the door is closed, and does not involve the operation to open the door while in operation, and ends automatically. This corresponds, for example, to printing execution, image quality maintenance that accompanies printing, and image quality maintenance such as cleaning that does not accompany printing but is operated within the printing unit 115 and the printing unit 116. The processing for executing the function is mainly controlled by the engine controller 13B.

Function type (5) in FIG. 3 corresponds to a function that does not involve the operation to open the door after the function execution is started, but all functions of the printing system 100 cannot be used until the function is finished. This corresponds, for example, to shutdown or firmware update. The processing for executing the function is controlled by the entire printing system 100 using both the main controller 13A and the engine controller 13B. Function type (6) in FIG. 3 corresponds to a function that does not involve the operation to open the door after the function execution is started, but some functions of the printing system 100 cannot be used until the function is finished. This corresponds, for example, to a function to reboot the main controller 13A only, which does not allow the operation of functions that use the main controller 13A as the function control unit of the printing system 100. The processing for executing the function is mainly controlled by the main controller 13A. Function type (7) in FIG. 3 corresponds to a function that does not involve the operation to open the door but involves a screen operation, and corresponds to functions other than Function types (4), (5), and (6). This corresponds, for example, to print job management, print control parameter management for paper type, print cost simulation, and operation result management. The processing for executing the function is mainly controlled by the main controller 13A. Here, the applicable functions are listed as an example, but further subdivided functions may also be applicable.

In the present embodiment, Function type (3) in FIG. 3, which involves the operation to open the door upon execution of the function, requires the interlock function installed in the printing system 100 to ensure safety, and also requires a screen operation, is defined as a “function that requires ensuring safety through UI operation”. Function types (4), (5), (6), and (7) in FIG. 3, which do not involve the operation to open the door and require a screen operation, are each defined as a “function that does not require ensuring safety through UI operation”.

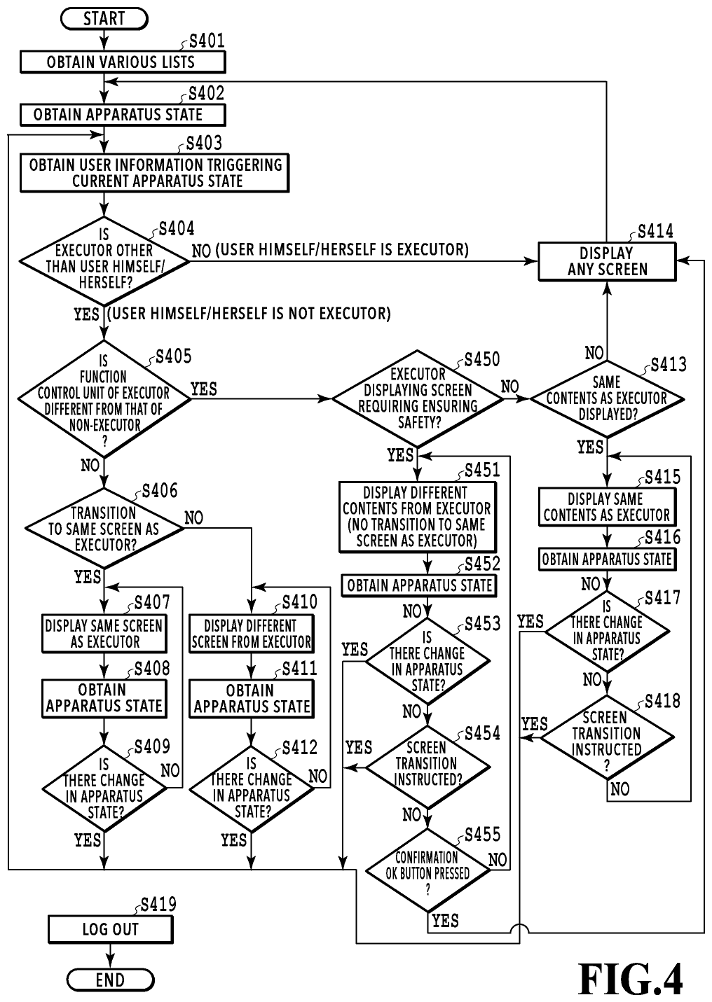

FIG. 4 is a flowchart related to the UI display contents on the display device shown in FIG. 2. The flowchart of FIG. 4 shows a flow of processing for determining which screen to display by referring to the apparatus state and the function type No. in a case where the user displays any screen. Specifically, the processing unit 131 determines whether to display any screen designated by the user as is, whether to display the same screen as the executor, whether to display a screen different from the executor, and whether to automatically switch the display contents. Furthermore, the processing unit 131 further determines the display contents in a case of automatic switching. While a function is being executed in the apparatus, the state of the apparatus becomes a state corresponding to that function. Therefore, upon execution of the processing according to the flowchart of FIG. 4, in a case where a certain user is executing a function of the apparatus, the UI display contents of other non-executors can be switched according to the function being executed. The flowchart of FIG. 4 will be described in detail later.

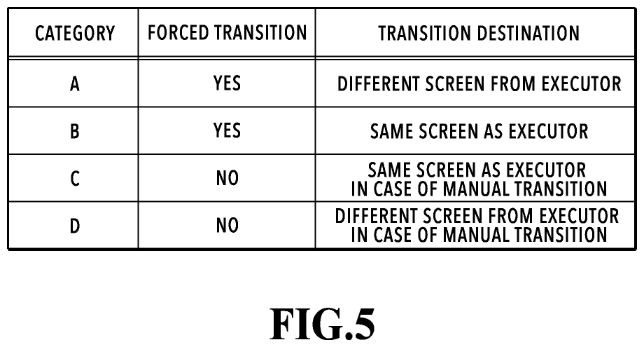

FIG. 5 shows an example of an action using four categories (A, B, C, and D) in a case of automatically switching the UI display contents. The actions on the UI display contents are broadly classified depending on whether the function control unit of the executor and the function control unit of the non-executor are the same or different. Categories A and B each correspond to a case where the function control unit of the executor and the function control unit of the non-executor are the same. Categories C and D each correspond to a case where the function control unit of the executor and the function control unit of the non-executor are different. Category A is a category in which the UI display contents of the transition destination are different from those of the executor of the function. Category B is a category in which the UI display contents of the transition destination are the same as those of the executor of the function. Category C is a category in which the screen is not forcibly transitioned, but in a case where a non-executor manually switches to a UI display related to the function being executed, the UI display contents are the same as those of the executor. Category D is a category in which the screen is not forcibly transitioned, but in a case where the non-executor manually switches to the UI display related to the function being executed, the UI display contents are different from those of the executor. Here, the four categories are used as an example, but various other patterns of categories can be used, such as patterns in which Categories A and B are further subdivided.

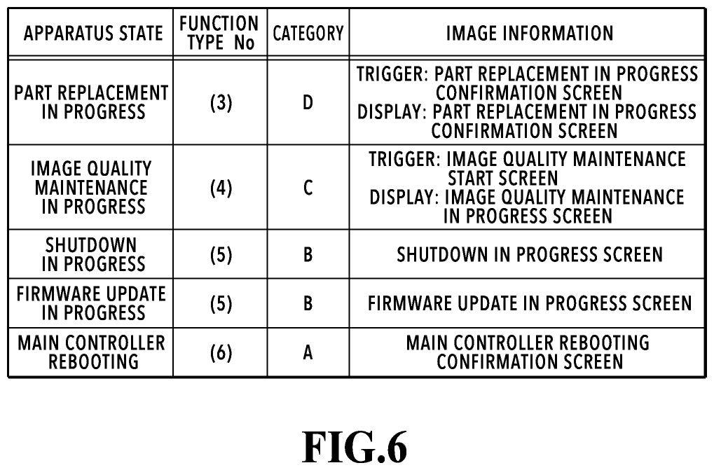

FIG. 6 shows a correspondence list of “Function type No.” and each category for the “apparatus state” indicating the state of the apparatus. Here, examples of the apparatus state during execution of the functions of the printing system 100 are categorized into part replacement, image quality maintenance, shutdown, firmware update, and main controller rebooting. FIG. 6 also shows screen information for each apparatus state is described. In the case of Category A, the screen information is information on a screen displayed to the non-executor. In the case of Category B, the screen information is information on the same screen as the executor. In the case of Category C, the screen information is information on a screen to be displayed with the same contents as the executor. In the case of Category D, the screen information is information on a screen to be displayed with different contents from the executor. Each specific apparatus state and screen operations of the non-executor will be described in detail later. Note that Function types (1) and (2) in FIG. 3 do not involve any screen operation, and therefore have no screen information defined according to the apparatus state in FIG. 6.

“The correspondence relationship and detailed screen information shown in FIG. 6 are merely an example, and there may be cases other than those described here. Each apparatus state, “function type No.”, category, and screen information may be associated with each other according to a method of using the apparatus. In a case of a function for which operation authority is to be concentrated to the executor only, or in a case where non-executors are not allowed to operate and information different from that of the executor is to be displayed, the corresponding apparatus state is preferably set to Category A. For example, in a case of a function that requires a screen operation restriction for a certain period of time such as rebooting the main controller 13A, where a non-executor can perform operations on the printing system 100 other than the screen operation, the corresponding apparatus state is preferably set to Category A to notify the state to the non-executor.

In a case of a function for which the same contents are to be forcibly displayed without distinguishing between the executor and the non-executor, the corresponding apparatus state is preferably set to Category B. As for a function that causes a significant change in the apparatus after the function execution, in particular, the corresponding apparatus state is preferably set to Category B in order to share the same progress with all users. Even if all functions of the printing system 100 cannot be used due to shutdown, firmware update or the like, the corresponding apparatus state is preferably set to Category B in order to share the same progress with all users.

In a case where the non-executor is permitted to operate other functions or display information even during the execution of the function, the corresponding apparatus state is preferably set to Category C or Category D. Particularly, in a case of a function for which the operation may be restricted for a long period of time for all users, or a function for which the execution priority may change depending on the situation, the corresponding apparatus state is preferably set to Category C or Category D. Alternatively, depending on the function characteristics, Category C may be used in a case of sharing with all users the state during the execution of the function, and Category D may be used in a case where the non-executor is encouraged to perform other tasks. The method of use is not limited thereto.

Here, since the printing system 100 of the present embodiment is configured to ensure safety, the conditions for restricting UI operations are localized based on apparatus safety regulations. For example, the functions are classified as shown in FIG. 3, and the “function that requires ensuring safety through UI operation” and the “function that does not require ensuring safety through UI operation” are clearly defined. Therefore, restrictions may be imposed on the non-executor only in a case of displaying a screen related to the “function that requires ensuring safety through UI operation”. Even if the executor is operating the “function that requires ensuring safety through UI operation”, in a case where the function is executed by the function control unit different from the function control unit executing the function being executed, the non-executor can continue the “function that does not require ensuring safety through UI operation”. For example, even if the executor is executing the part replacement, the non-executor can continue to use the print job management, paper type print control parameter management function, print cost simulation or the like, which is the “function that does not require ensuring safety through UI operation”, because the function control unit is different. This eliminates the need to assign Category A, in which the non-executor is not allowed to operate while the executor is executing the “function that requires ensuring safety through UI operation” as in the related art. This makes it possible to increase the number of functions to be assigned to Category D, which can be operated by the non-executor on any screen.

The printing system 100 according to the present embodiment is also configured to ensure the safety of the remote UI placed remotely, thus enabling the same screen switching as the main body UI in FIG. 6. Unlike the related art, it is no longer necessary for the remote UI user to assign Category A in which the screen is forcibly switched in all cases.

### <Detailed Description of FIG. 4>

The flowchart of FIG. 4 will be described in detail below. In the following description, the “user himself/herself” refers to the user who is logged in to the display device 138. In S401, in a case where the user himself/herself wants to display any screen, the processing unit 131 obtains the function classification list in FIG. 3, the display switching category list in FIG. 5, and the correspondence list of the apparatus state and category in FIG. 6, and then the processing proceeds to S402. In S402, the processing unit 131 obtains the apparatus state through the state obtaining unit 131a, and then the processing proceeds to S403. In S403, the processing unit 131 obtains the user information on the user who has caused a trigger to set the apparatus state to the current apparatus state through the state obtaining unit 131a, and then the processing proceeds to S404. For example, the processing unit 131 obtains ID information that identifies each user. In S404, the processing unit 131 determines from the user information obtained in S403 whether the executor is other than the user himself/herself. In a case where the executor is other than the user himself/herself, the processing proceeds to S405. In a case where the executor is the user himself/herself, the processing proceeds to S414.

In S405, the processing unit 131 determines whether the function control unit of the executor is different from the function control unit of the non-executor. Based on the determination result in S405, it is also possible to display on the screen of the non-executor that the execution button of the function used by the same function control unit as that of part replacement cannot be pressed, for example, during the period in which the apparatus state is “part replacement in progress”.

In a case where the function control unit of the executor is the same as the function control unit of the non-executor, the processing proceeds to S406. The case where the function control unit of the executor is the same as the function control unit of the non-executor corresponds to the case where the function type No. is (5) or (6) and the category is Category A or Category B, as shown in FIG. 6. In this case, the screen is forcibly transitioned.

In a case where the function control unit of the executor is different from the function control unit of the non-executor, the processing proceeds to S450. The case where the function control unit of the executor is different from the function control unit of the non-executor corresponds to the case where the function type No. is (3) or (4) and the category is Category C or Category D, as shown in FIG. 6.

In S406, the processing unit 131 determines whether the apparatus state allows transition to the same screen as that of the executor. In a case where the apparatus state allows transition to the same screen as that of the executor, the processing proceeds to S407. This corresponds to the case where the category is Category B. In a case where the apparatus state does not allow transition to the same screen as that of the executor, the processing proceeds to S410. This corresponds to the case where the category is Category A.

In S407, the processing unit 131 displays on the screen of the user himself/herself the same screen as that of the executor described in the screen information in FIG. 6, and then the processing proceeds to S408. In S408, the processing unit 131 obtains the apparatus state through the state obtaining unit 131a, and then the processing proceeds to S409. In S409, the processing unit 131 determines whether there is a change in the apparatus state obtained in S408. In a case where there is a change in the apparatus state, the processing returns to S403. In a case where there is no change in the apparatus state, the processing returns to S407. The determination in S409 is performed periodically.

In S410, the processing unit 131 displays a screen different from that of the executor on the screen of the user himself/herself, and then the processing proceeds to S411. In S409, the processing unit 131 determines whether there is a change in the apparatus state obtained in S411. In a case where there is a change in the apparatus state, the processing returns to S403. In a case where there is no change in the apparatus state, the processing returns to S410. The determination in S412 is performed periodically.

In S450, the processing unit 131 determines whether the executor is displaying a screen that requires ensuring safety. In a case where the executor is displaying the screen that requires ensuring safety, the processing proceeds to S451. This corresponds to the case where the category is Category D. In a case where the executor is not displaying the screen that requires ensuring safety, the processing proceeds to S413. This corresponds to the case where the category is Category C.

In S413, the processing unit 131 determines whether to display the same contents as those of the executor on the screen of the user himself/herself. In a case where the same contents as those of the executor are displayed on the screen of the user himself/herself, the processing proceeds to S415. In a case where the same contents as those of the executor are not displayed on the screen of the user himself/herself, the processing proceeds to S414, where the processing unit 131 displays any screen on the screen of the user himself/herself. Details of the case of proceeding to S415 are as follows. In a case where the function type No. is (4) and the category is Category C in the correspondence list of the apparatus state and category shown in FIG. 6, it is determined whether the user himself/herself has specified the trigger screen described in the screen information in FIG. 6. In a case where the same contents as those of the executor are to be displayed on the screen specified by the user himself/herself, the processing proceeds to S415. In a case where the apparatus state is Category C, the reference destination of the executor's screen does not have to be described in the screen information in FIG. 6, but may be obtained separately from the executor's screen information.

In S415, the processing unit 131 displays the same contents as those of the executor on the screen of the user himself/herself, and then the processing proceeds to S416. In S416, the processing unit 131 obtains the apparatus state through the state obtaining unit 131a, and then the processing proceeds to S417. In S417, the processing unit 131 determines whether there is a change in the apparatus state obtained in S416. In a case where there is a change in the apparatus state, the processing returns to S403. In a case where there is no change in the apparatus state, the processing proceeds to S418. In S418, the processing unit 131 determines whether a screen transition instruction has been received. In a case where the screen transition instruction has been received, the processing returns to S403. In a case where no screen transition instruction has been received, the processing returns to S415. The processing of S417 and S418 is performed periodically.

In S451, the processing unit 131 displays contents different from those of the executor on the screen of the user himself/herself, and then the processing proceeds to S452. In S452, the processing unit 131 obtains the apparatus state through the state obtaining unit 131a, and then the processing proceeds to S453. In S453, the processing unit 131 determines whether there is a change in the apparatus state obtained in S452. In a case where there is a change in the apparatus state, the processing returns to S403. If there is no change in the apparatus state, the processing proceeds to S454. In S454, the processing unit 131 determines whether a screen transition instruction has been received. In a case where the screen transition instruction has been received, the processing returns to S403. In a case where no screen transition instruction has been received, the processing proceeds to S455. The processing of S453 and S454 is performed periodically.

In S455, the processing unit 131 determines whether a confirmation OK button for indicating the intention that notification contents on the screen have been confirmed is pressed by the operation of the user himself/herself on his/her own screen. In a case where the confirmation OK button is pressed by the operation of the user himself/herself, the processing proceeds to S414. In a case where the confirmation OK button is not pressed by the operation of the user himself/herself, the processing returns to S451. The currently specified screen continues to be displayed on the screen of the user himself/herself until the confirmation OK button is pressed. In other words, the screen of the user himself/herself is not changed until a screen operation is performed.

In S414, the processing unit 131 displays any screen specified by the user himself/herself on his/her own screen, and then the processing returns to S402. Note that, in a case where the target user logs out while various screens are being displayed, the processing ends (S418). More specific examples of each category will be described below.

### <Specific Example of Category A>

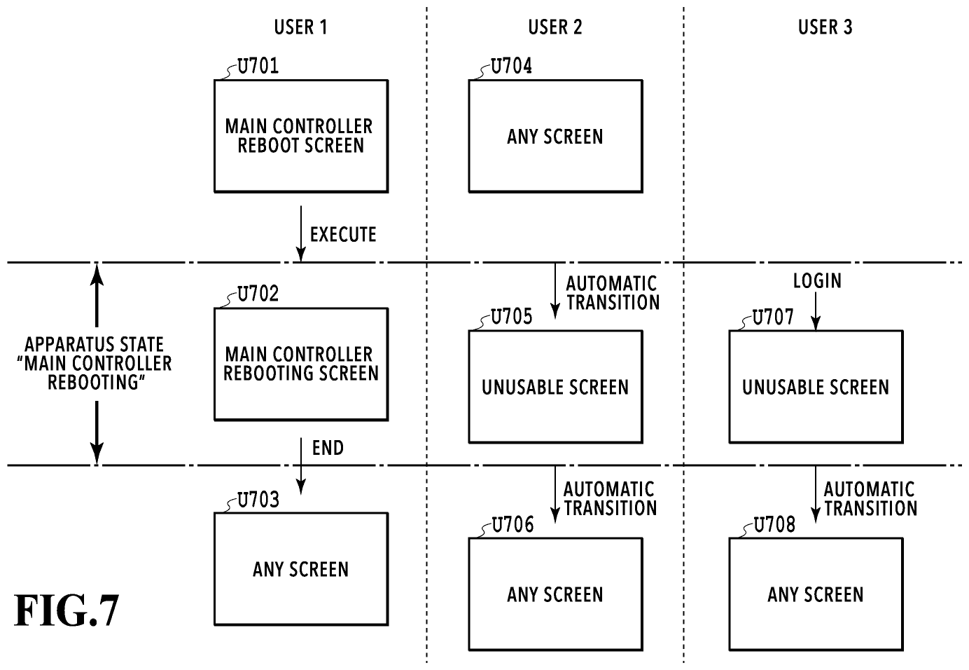

FIG. 7 shows an example of a case where the main controller is rebooted as a specific example of Category A. User 1 is the executor of the function, and Users 2 and 3 are non-executors of the function. FIG. 7 shows the transition of the screen display for each user from top to bottom.

In a case where User 1 performs an operation to reboot the main controller on a main controller reboot screen (U701), the apparatus state is set to “main controller rebooting”, and the screen of User 1 displays a main controller rebooting screen (U702). The area between the two dotted lines in FIG. 7 indicates that the apparatus state is “main controller rebooting”. The apparatus state of “main controller rebooting” is Category A in the list of FIG. 6, and the corresponding screen information is an unusable screen. Therefore, the screen of User 2 displaying any screen (U704) before the execution of the operation to reboot the main controller by User 1 is forcibly and automatically transitioned to an unusable screen (U705) when the apparatus state is set to “main controller rebooting”.

The display contents control for User 2 will be described by applying it to the flowchart of FIG. 4. This is the stage where the screen of S410 is displayed because the apparatus state obtained in S402 is “main controller rebooting”, and it is determined in S404 that the executor is other than the user himself/herself, and it is determined in S406 that the function control unit of the executor is the same as the function control unit of the non-executor. The unusable screen displays a message such as “Unusable because the main controller is currently rebooting” on the screen, for example, and displays that all functions are unusable by disabling all buttons, or the like. For new User 3 logged in during the period in which the apparatus state is “main controller rebooting”, the initial screen after login is an unusable screen (U707). Here, the description is given of the example where the unusable screen is used as the screen that is different from that of the executor. However, a screen that can be used not only for display but also for settings and the like may also be displayed as long as the execution of functions is not affected thereby.

As User 1 finishes rebooting the main controller, the user pressing an end button, automatic system shutdown processing or the like causes the apparatus state to be no longer set to “main controller rebooting”. At this point, the screen display of User 1 is switched to any screen (U703).

The screen displays of Users 2 and 3 are automatically transitioned to any screens (U706 and U708) in a case where the apparatus state is no longer “main controller rebooting”. This is applied to the flowchart of FIG. 4 as follows. In S412, the processing unit 131 determines that the apparatus state obtained in S411 has changed from “main controller rebooting”. In this case, in S404, the processing unit 131 determines that the trigger to change to the current apparatus state (assumed to be “normal state”) is set by someone other than the user himself/herself, and then the processing proceeds to S405. In S405, the processing unit 131 determines that the function processing unit of the executor is different from the function processing unit of the non-executor, and then the processing proceeds to S450. In S450, the processing unit 131 determines that the executor is not displaying the screen that requires ensuring safety, and then the processing proceeds to S413. In S413, the processing unit 131 proceeds to a process of displaying any screen (S414). In S414, any screens (U706 and U708) are displayed on the screens of User 2 and User 3. Any screen U706 may display the same screen as U704. Any screen U708 may display a home screen that is normally displayed after login. Alternatively, both any screens (U706 and U708) may display the contents of the result of the main controller reboot performed by User 1.

Here, the same unusable screen is displayed for the non-executors User 2 and User 3, but the display contents for more than one non-executor may be different. If the apparatus state after the change in S412 is one of the apparatus states included in the corresponding list of FIG. 6, the display operation of each category may be performed in S405, S450 or S413.

### <Specific Example of Category B>

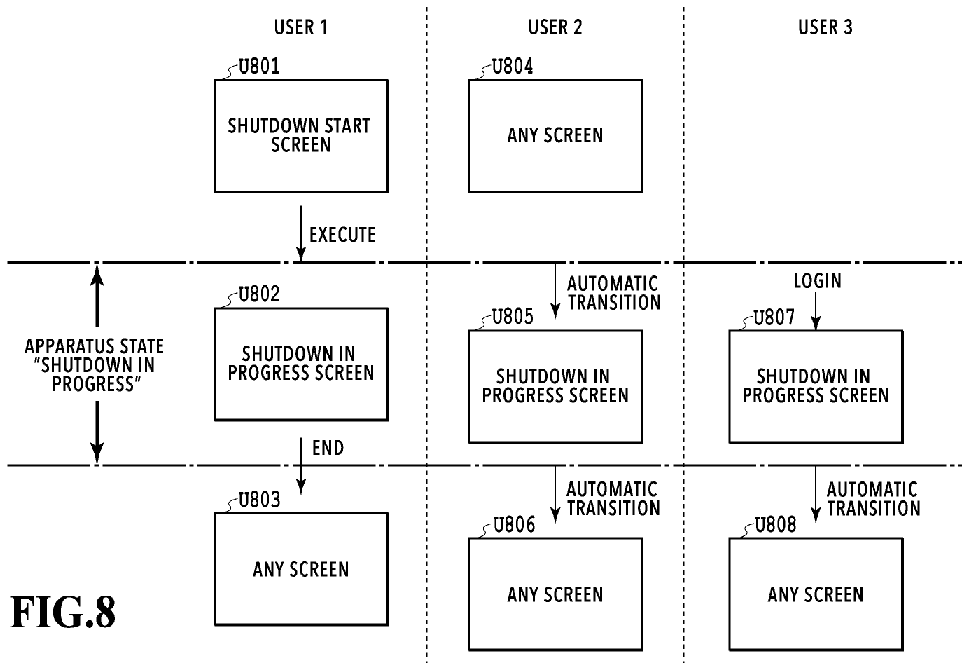

FIG. 8 shows an example of a case where shutdown is executed as a specific example of Category B. User 1 is the executor of the function, and User 2 and User 3 are non-executors of the function. FIG. 8 shows the transition of the screen display for each user from top to bottom.

As User 1 performs an operation to execute shutdown on a shutdown start screen (U801), the apparatus state is set to “shutdown in progress”, and the screen of User 1 displays a shutdown screen (U802). The area between the two dotted lines in FIG. 8 indicates that the apparatus state is “shutdown in progress”. The apparatus state of “shutdown in progress” is Category B in the list of FIG. 6. Therefore, the screen of User 2 displaying any screen (U804) before the operation to execute shutdown by User 1 is forcibly and automatically transitioned to a shutdown screen (U805) when the apparatus state is set to “shutdown in progress”. The display contents control of User 2 will be described by applying it to the flowchart of FIG. 4. This is the stage where the screen of S407 is displayed because the apparatus state obtained in S402 is “shutdown in progress”, and it is determined in S404 that the executor is other than the user himself/herself, and it is also determined in S406 that the function control unit of the executor is the same as the function control unit of the non-executor. The shutdown screen displays the progress of the shutdown, for example, as a percentage or remaining time. Once the apparatus is shut down, all users can no longer use the apparatus. By displaying the same shutdown screen as that of the executor to the non-executor, the non-executor can know that the apparatus is shutting down and can also know details such as the remaining time. For new User 3 logged in while the apparatus state is “shutdown in progress”, the initial screen after login is a shutdown screen (U807).

In a case of shutdown to terminate the entire printing system 100, the main controller is also terminated. Therefore, in a case where the shutdown of the apparatus ends, the UI display of the apparatus also ends on the display devices of all users. However, in a case where only the print engine unit controlled by the engine controller 13B of the printing system 100 is shut down, the main controller unit is in an active state, and therefore the UI display continues on the display devices of all users. In this case, as the shutdown of the apparatus ends, the user pressing an end button, automatic system shutdown processing or the like causes the apparatus state to be no longer set to “shutdown in progress”. At this point, the screen display of User 1 is switched to any screen (U803). Any screen (U803) is designed to make it easy to shift to other operations, taking into consideration user operability, such as a home screen display.

The screen displays of User 2 and User 3 are automatically transitioned to any screens (U806 and U808) when the apparatus state is no longer “shutdown in progress”. This is applied to the flowchart of FIG. 4 as follows. In S409, the processing unit 131 determines that the apparatus state obtained in S408 has changed from “shutdown in progress”. In this case, in S404, the processing unit 131 determines that the trigger to change to the current apparatus state (assumed to be “normal state”) is set by someone other than the user himself/herself, and then the processing proceeds to S405. In S405, the processing unit 131 determines that the function processing unit of the executor is different from the function processing unit of the non-executor, and then the processing proceeds to S450. In S450, the processing unit 131 determines that the executor is not displaying the screen that requires ensuring safety, and then the processing proceeds to S413. In S413, the processing unit 131 proceeds to a process of displaying any screen (S414). In S414, any screens (U806 and U808) are displayed on the screens of User 2 and User 3. Any screen U806 may display the same screen as U804. Any screen U808 may display a home screen that is normally displayed after login. These screens (U806 and U808) may be any screens in which user operability and safety are considered. In a case where the apparatus state after the change in S412 is one of the apparatus states included in the corresponding list of FIG. 6, the display operation of each category may be performed in S405, S450 or S413.

### <Specific Example of Category C>

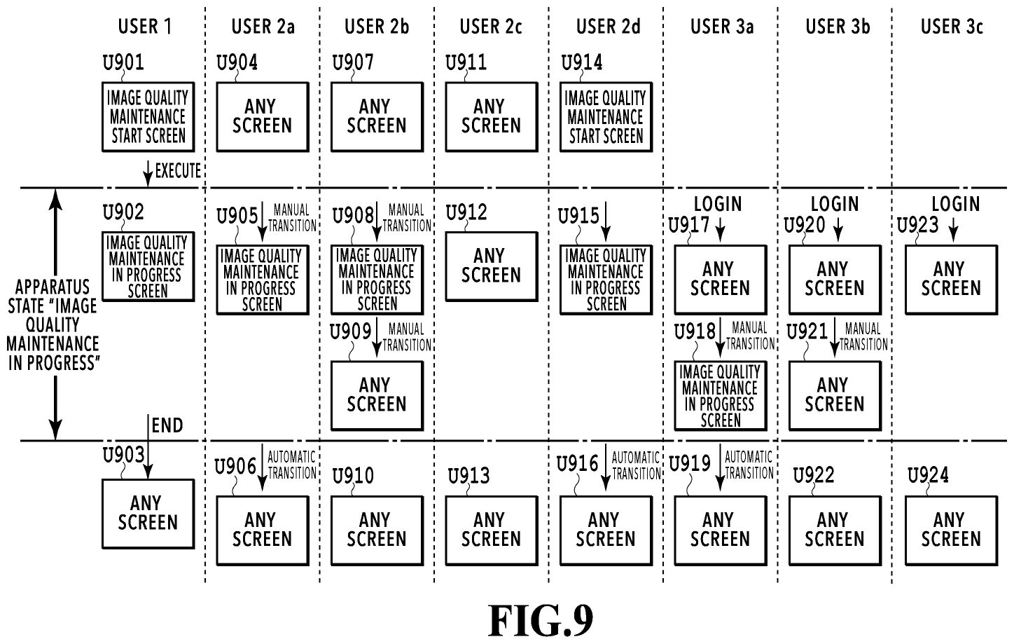

FIG. 9 shows an example of a case where image quality maintenance is performed as a specific example of Category C. The image quality maintenance here means a maintenance function for improving print image quality. User 1 is the executor of the function, and users 2a, 2b, 2c, 2d, 3a, 3b, and 3c are non-executors of the function. FIG. 9 shows the transition of the screen display for each user from top to bottom.

In a case where User 1 performs an operation to execute image quality maintenance on an image quality maintenance start screen (U901), the apparatus state is set to “image quality maintenance in progress” and the screen of User 1 displays an image quality maintenance in progress screen (U902). The area between the two dotted lines in FIG. 9 indicates that the apparatus state is “image quality maintenance in progress”. User 2a, User 2b, and User 2c are users displaying any screens (U904, U907, and U911) before the operation to execute the image quality maintenance by User 1. User 2d is a user displaying an image maintenance start screen (U914) before the operation to execute the image quality maintenance by User 1. The apparatus state of “image quality maintenance in progress” is Category C in the list of FIG. 6. Therefore, even if the apparatus state is set to “image quality maintenance in progress”, the screen displays of Users 2a, 2b, and 2c are not forcibly switched. Only the screen display of User 2d is automatically transitioned to the same image quality maintenance in progress screen as the executor.

User 2a, User 2b, and User 2c will be described by applying the flowchart of FIG. 4. This is the stage where the screen of S414 is displayed because any screen specified by the user is not the trigger screen described in the screen information of FIG. 6, even though the apparatus state obtained in S402 is “image quality maintenance in progress”. In other words, for Users 2a, 2b, and 2c, the processing of S404: YES, S405: YES, S450: NO, and S413: NO is executed, and any screen in S414 is displayed.

User 2d will be described by applying the flowchart of FIG. 4. This corresponds to a case where the apparatus state obtained in S402 is “image quality maintenance in progress”, and the screen specified by the user is the trigger screen described in the screen information of FIG. 6. Therefore, the processing of S404: YES, S405: YES, S450: NO, and S413: YES is executed. Specifically, the processing unit 131 determines in S413 to display the same contents as those of the executor, and displays an image quality maintenance in progress screen (U915) in S415. Here, description will be given of the reason why the processing of S405 proceeds to “YES”. The engine controller 13B is operating since User 1 performs the “image quality maintenance” operation. On the other hand, the engine controller 13B is not operating since User 2d is only displaying the “image quality maintenance start screen”. Therefore, the processing of S405 proceeds to “YES” since the function control unit of User 1 (executor) is different from the function control unit of User 2d (non-executor).

In a case where User 2a and User 2b manually transition to the image quality maintenance start screen during the period in which the apparatus state is “image quality maintenance in progress”, the same image quality maintenance in progress screen (U905 and U908) as the executor is displayed. In a case where User 2b further manually transitions to any screen other than the image quality maintenance start screen during the same period, any screen (U909) is displayed. During the same period, User 2c who does not manually transition to the image quality maintenance start screen has any screen (U912) always displayed, other than the image quality maintenance in progress screen. The image quality maintenance in progress screen displays the progress of image quality maintenance, for example, as a percentage or remaining time. The image quality maintenance takes time to execute, and other functions may not be available during the execution of the maintenance. In such a case, by displaying the same image quality maintenance in progress screen as the executor to non-executors, the non-executors can know details about when the other functions will be available for use.

For new Users 3a, 3b, and 3c logged in during the period in which the apparatus state is “image quality maintenance in progress”, any screens (U917, U920, and U923), such as a home screen, are displayed after login. In a case where User 3a manually transitions to the image quality maintenance start screen during the period of “image quality maintenance in progress”, the same image quality maintenance in progress screen (U918) as the executor is displayed. In a case where User 3b manually transitions to any screen other than the image quality maintenance start screen during the same period, any screen (U921) is displayed. During the same period, User 3c who does not manually transition to the image quality maintenance start screen has any screen (U923) always displayed, other than the image quality maintenance in progress screen.

In a case where User 1 finishes the image quality maintenance, the user pressing an end button, automatic system shutdown processing or the like causes the apparatus state to be no longer set to “image quality maintenance in progress”. At this point, the screen display of User 1 is switched to any screen (U903). Any screen (U903) is a screen in which user operability and safety is considered, such as the same screen display as U901 in a case where it is designed to make it easy to continue the image quality maintenance, or a home screen display in a case where it is designed to make it easy to shift to other operations.

User 2a, User 2d, and User 3a are users displaying the image quality maintenance in progress screen during the period in which the apparatus state is image quality maintenance in progress. These users automatically transition to any screens (U906, U916, and U919) in a case where the apparatus state is no longer “image quality maintenance in progress”. This is applied to the flowchart of FIG. 4 as follows. In S417, the processing unit 131 determines that the apparatus state obtained in S416 has changed from “image quality maintenance in progress”. Any screens (U906, U916, and U919) of the respective users may be a home screen, or a screen displaying details of the result of image quality maintenance performed by User 1, or the like. Any screens (U906 and U916) of User 2a and User 2d may be any screens (U904 and U914) before the apparatus state is set to image quality maintenance in progress. In a case where the apparatus state after the change in S417 is one of the apparatus states included in the corresponding list of FIG. 6, the display operation of each category may be performed in S405, S450 or S413. Users 2b, 2c, 3b, and 3c displaying any screens during the period in which the apparatus state is image quality maintenance in progress have the same contents of any screens before and after the apparatus state is switched from “image quality maintenance in progress”.

### <Specific Example of Category D>

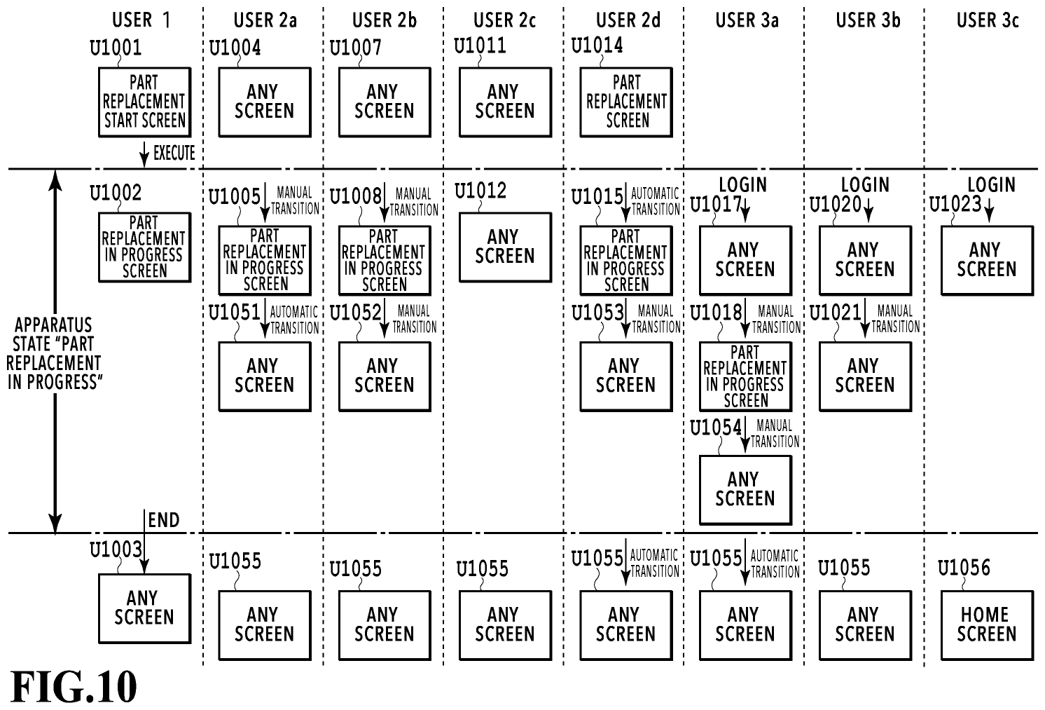

FIG. 10 shows an example of a case where part replacement is executed as a specific example of Category D. User 1 is the executor of the function, and Users 2a, 2b, 2c, 2d, 3a, 3b, and 3c are non-executors of the function. FIG. 10 shows the transition of the screen display for each user from top to bottom.

As User 1 performs an operation to execute the part replacement on a part replacement start screen (U1001), the apparatus state is set to “part replacement in progress” and the screen of User 1 displays a part replacement in progress screen (U1002). The area between the two dotted lines in FIG. 10 indicates that the apparatus state is “part replacement in progress”. User 2a, User 2b, and User 2c are users displaying any screens (U1004, U1007, and U1011) before the operation to execute the part replacement by User 1. User 2d is a user displaying a part replacement screen (U1014) before the operation to execute the part replacement by User 1. The apparatus state of “part replacement in progress” is Category D in the list of FIG. 6. Therefore, even if the apparatus state is switched to “part replacement in progress”, the screen displays of Users 2a, 2b, and 2c are not forcibly switched. The screen of User 2d automatically transitions to a part replacement in progress screen with contents different from those of the executor only in the screen display. One example of the part replacement in progress screen with contents different from those of the executor is a part replacement in progress screen displayed on the screen of User 2d in a state where a button for executing the part replacement function is disabled.

User 2a, User 2b, and User 2c will be described by applying the flowchart of FIG. 4. The apparatus state obtained in S402 is “part replacement in progress”, and the processing of S404: YES, S405: YES, and S450: YES is executed. In S450, a screen with contents different from those of the executor is displayed.

User 2d will be described by applying the flowchart of FIG. 4. The apparatus state obtained in S402 is “part replacement in progress”, and the processing of S404: YES, S405: YES, and S450: YES is executed. Specifically, the processing unit 131 is displaying a part replacement in progress screen (U1015) with contents different from those of the executor in S451. Here, description will be given of the reason why the processing of S405 proceeds to “YES”. The engine controller 13B is operating since User 1 is performing the “part replacement” operation. On the other hand, the engine controller 13B is not operating since User 2d is only displaying the “part replacement screen”. Therefore, the processing of S405 proceeds to “YES”, since the function control unit of User 1 (executor) is different from the function control unit of User 2d (non-executor).

In a case where User 2a and User 2b manually transition to the part replacement start screen during the period in which the apparatus state is “part replacement in progress”, part replacement in progress screens (U1005 and U1008) with different display contents from those of the executor are displayed. On the part replacement in progress screen of the non-executor, the button for executing the part replacement function may be displayed in a disabled state. In a case where User 2a, User 2b, and User 2d manually transition to any screens other than the part replacement screen during the same period, any screens (U1051, U1052, and U1053) are displayed. During the same period, User 2c who does not manually transition to the part replacement screen has any screen (U1012) always displayed, other than the part replacement in progress screen.

For new Users 3a, 3b, and 3c logged in during the period in which the apparatus state is “part replacement in progress”, any screens (U1017, U1020, and U1023), such as a home screen, are displayed after login. In a case where User 3a manually transitions to the part replacement screen during the period of “part replacement in progress”, a part replacement in progress screen (U1018) with different display contents from those of the executor is displayed. On the part replacement in progress screen for the non-executors, the button for executing the part replacement function may be displayed in a disabled state. In a case where User 3b manually transitions to any screen other than the part replacement screen during the same period, any screen (U1021) is displayed. For User 3c who does not manually transition to the part replacement screen during the same period, any screen (U1023) other than the part replacement in progress screen is always displayed. In a case where User 3a manually transitions to any screen other than the part replacement screen during the same period, any screen (U1054) is displayed.

Note that, during the period in which the apparatus state is “part replacement in progress”, the execution buttons for other functions that use the engine controller 13B, which is the same function control unit as the part replacement, may be disabled, for example, to display that the functions cannot be executed. The part replacement is often performed by the user as the executor coming close to the apparatus. Therefore, if other functions that use the same function control unit are activated while the part replacement is in progress, the executor may be exposed to danger. By restricting the use of functions that use the same function control unit during the execution of the “function that requires ensuring safety through UI operation”, both the executor and non-executor can operate while ensuring safety.

In a case where User 1 finishes the part replacement, the user pressing an end button, automatic system shutdown processing or the like causes the apparatus state to be no longer set to “part replacement in progress”. At this point, the screen display of User 1 is switched to any screen (U1003). Any screen (U1003) is a screen in which user operability and safety are considered, such as the same screen display as U1001 if it is designed to make it easy to continue the part replacement, or a home screen display if it is designed to make it easy to shift to other operations.

Users 2a, 2b, 2c, 3a, 3b, and 3c displaying any screens during the period in which the apparatus state is the part replacement in progress have the same contents of any screens before and after the apparatus state is switched from “part replacement in progress”. In a case where the part replacement in progress screen is displayed when the apparatus state is no longer “part replacement in progress”, these users automatically transition to any screens (U1055). Specifically, the processing of S404: YES, S405: YES, S450: NO, and S413: NO is executed, and any screen (U1055) is displayed in S414. Any screen (U1055) of each user may be a home screen (U1056) or a screen displaying details of the result of the part replacement performed by User 1. The above is the detailed description of each category. As described above, the determination of whether the safety is ensured makes it possible to flexibly control the display contents according to the work content.

### <Example of Screen Display Layout>

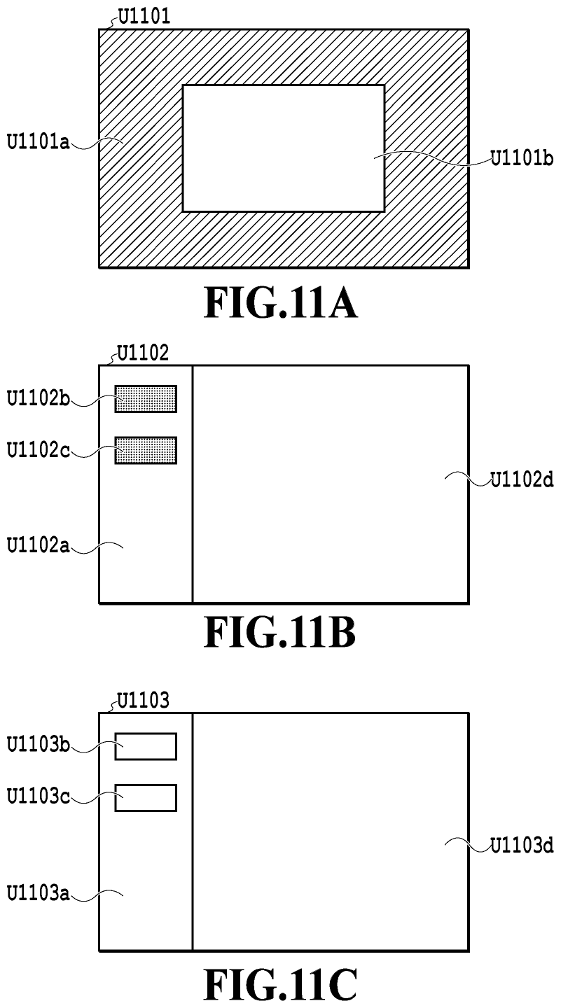

FIGS. 11A, 11B, and 11C show examples of display layout for non-executors of functions displayed by the display control unit 131b. In a case where the non-executors are only allowed to display information related to the function during execution and are not allowed to perform other operations, a layout such as a screen U1101 shown in FIG. 11A or a screen U1102 shown in FIG. 11B, for example, is effective. In the screen U1101, a normal screen is entirely masked as in a region U1101a, and information is displayed as a pop-up on top of it as in a region U1101b. Such masking can also restrict other operations. In the screen U1102 shown in FIG. 11B, a region U1102d is a display region related to the function being executed, and a region U1102a is a display region related to other functions. Regions U1102b and U1102c are execution buttons related to the other functions. The other operations can be restricted by disabling the execution buttons related to the other functions. With such a display, execution of other functions cannot be started while a certain function is being executed, thus preventing switching between the executer and non-executor.

However, there may be a case where a non-executor needs to execute other functions while a certain function is being executed. In that case, it is possible if the screen display of the non-executor is a display such as a screen U1103 shown in FIG. 11C. The screen U1103 has the same layout as the screen U1102, but execution buttons U1103b and U1103c related to other functions are usable. Therefore, with this display, the execution of other functions can be started while a certain function is being executed, and the executer and the non-executor are switched.

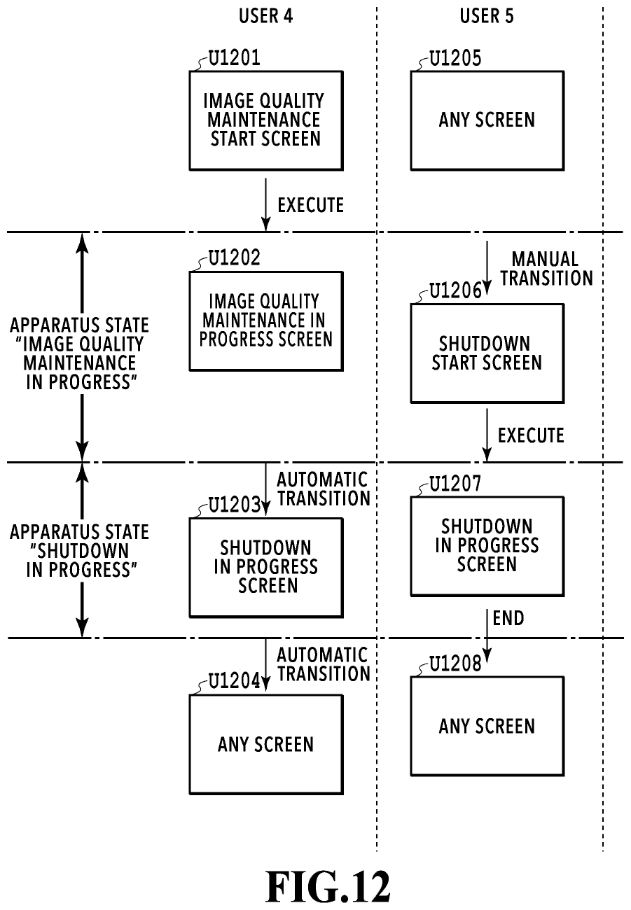

FIG. 12 shows a specific example of screen display switching. As User 4 executes image quality maintenance from an image quality maintenance start screen (U1201), the apparatus state is set to “image quality maintenance in progress”. Since “image quality maintenance in progress” is Category C in the correspondence list of FIG. 6, the screen of User 5 displaying any screen (U1205) is not switched automatically. Here, in a case where the UI display of User 5 as the non-executor of the function is such as the screen U1103 in FIG. 11C, it is possible to execute other functions. For example, it is assumed that the apparatus can execute the shutdown function during “image quality maintenance in progress”. In this case, since User 5 can execute shutdown from a shutdown start screen (U1206) during the period of “image quality maintenance in progress”, the apparatus state is switched to “shutdown in progress”. The display contents of User 5 are switched to the shutdown in progress screen, and the screen of User 4, who was the executor of image quality maintenance until just before, is automatically switched to the screen of the non-executor during shutdown. Subsequent display contents are the same as in the above example. By thus selecting the display layout of the non-executor in accordance with the relationship between the functions of the apparatus, the user operability can be further improved.

### <Example of Switching List to be Applied Based on User Information>

The above description has been given of the example where the correspondence list as shown in FIG. 6 is applied uniformly to all users. However, switching the list to be applied based on user information allows for more flexible control of display contents.

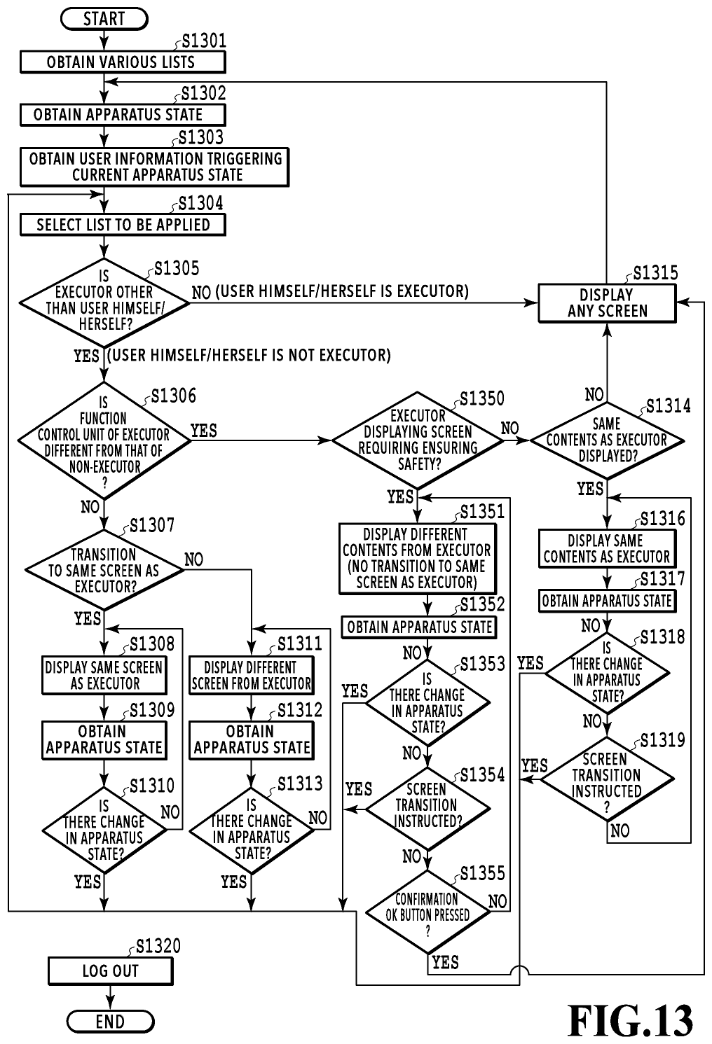

FIG. 13 is a flowchart obtained by adding a step of switching the list to be applied based on the information of the executor to the flowchart of FIG. 4. This makes it possible to flexibly switch the display contents of the non-executor according to user information of the executor. Specifically, selecting the list to be applied based on the obtained user information (S1304) is added between S403 and S404 in the flowchart of FIG. 4. The user information obtained in S1303 may be detailed user information including plural pieces of information, rather than single information such as ID information for identifying the user. The other processing is the same as that of FIG. 4, and thus description thereof is omitted.

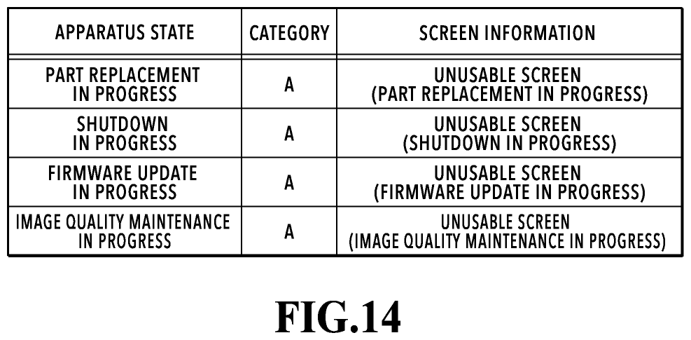

One example of the user information for determining the list to be applied is type information of the display device used by the user. The type information of the display device used by the user can be identified by an IP address or the like. For example, if the user who triggered the current apparatus state is the main body UI user based on the user information obtained in S1303, a correspondence list of FIG. 14 is applied. By classifying all apparatus states into Category A, different contents from those of the main body UI user as the executor of the function can be displayed to the remote UI user as the non-executor of the function.

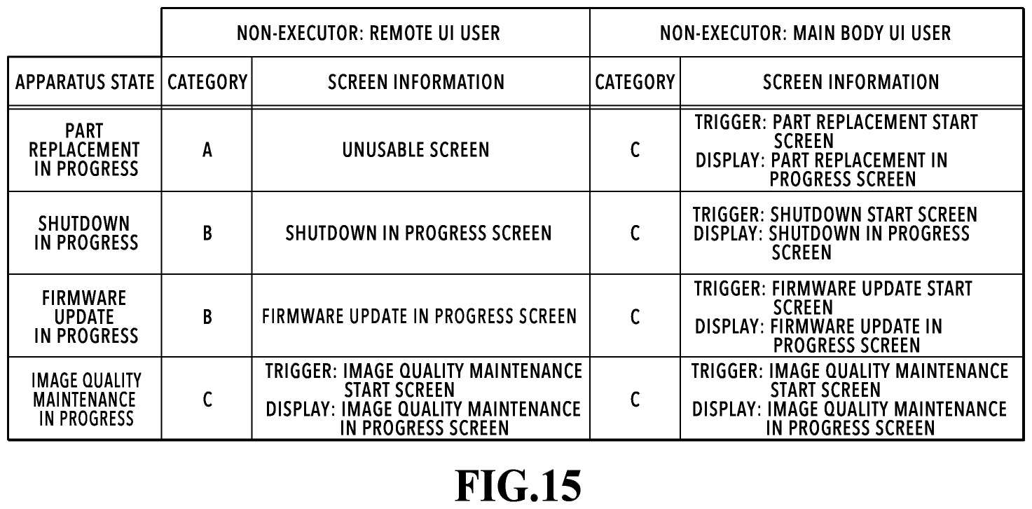

There is also a case where the executor is determined to be the remote UI user from the user information obtained in the S1303. FIG. 15 shows an example of a correspondence list to be applied in this case. In a case where the executor is the remote UI user, the category of each apparatus state is changed depending on whether the non-executor is the remote UI user or the main body UI user. As in the example of FIG. 15, if the main body UI user is the non-executor, classifying all apparatus states into Category C makes it possible to perform the same display as the executor and to display any screen, even though the main body UI user is the non-executor.

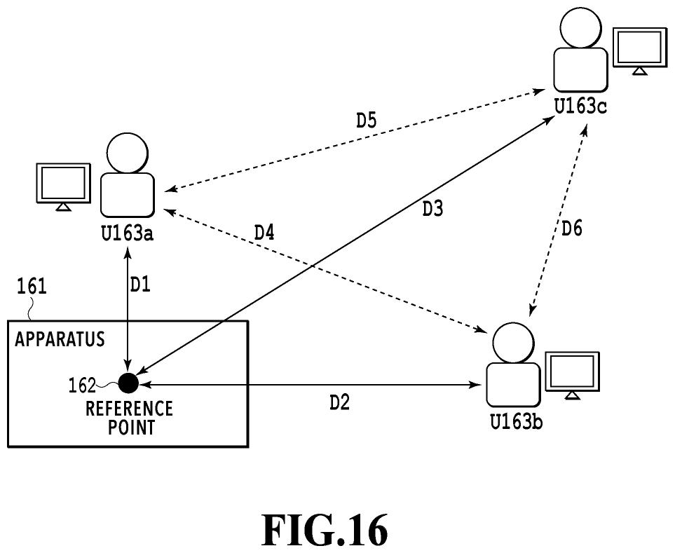

Furthermore, one example of the user information for determining the list to be applied is user position information. If the display device used by the user has a position obtaining function such as GPS (Global Positioning System), the user position information can be obtained as the user information. The distance between the user and the apparatus varies with the use of a device capable of displaying in a wireless environment. FIG. 16 is an image diagram showing plural users (U163a, U163b, and U163c) located in various positions with individual display devices relative to an apparatus 161 disposed. All users can be executors or non-executors. For example, the user position information is distance information of each user from a certain reference point. In this case, the distance information changes with the position of the reference point. In a case where a reference point 162 is set in the apparatus 161, as in the case of the reference point 162 in FIG. 16, the position information is distance information from the display device of each user.

With reference to FIG. 16, the magnitude relation of distance is D1<D2<D3, where D1, D2, and D3 represent the distance information of the users U163a, U163b, and U163c from the reference point 162, respectively. With the user U163b set as the executor of the function, the user U163a is located closer to the apparatus 161 than the executor, and the user U163c is located farther from the apparatus 161 than the executor.

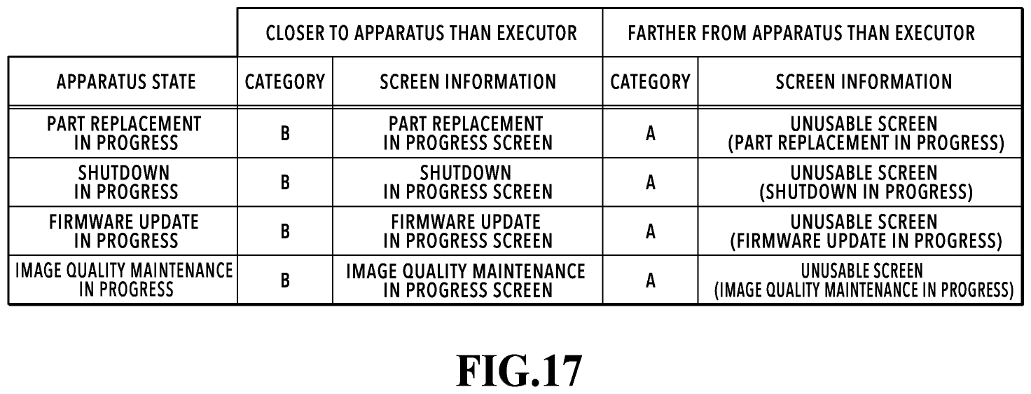

FIG. 17 shows an example of a correspondence list for switching the display contents of the non-executors depending on the distance as a result of comparing the position of the apparatus 161 from the reference point with the executor. In a case where the user farther from the apparatus 161 than the executor is not allowed to perform any operation, this can be achieved by setting the category for all apparatus states of the user to A. In a case where the user closer to the apparatus than the executor is allowed to display and operate the same as the executor, this can be achieved by setting the category for all apparatus states of the user to B. The contents displayed on the screen may be changed depending on the distance of each of the plural non-executors. For example, a message such as “Please move away from the apparatus.” may be displayed on the screen of a non-executor who is close to the apparatus at a dangerous distance, to help the non-executor avoid danger.

The reference point can also be the position of the executor. If the executor of the function is the user U163b, the distances between the executor and the non-executors, the user 163a and the user 163c, are D4 and D6, respectively, and the magnitude relation of distance is D4>D6. The user U163c is closer to the user U163b as the executor than the user U163a, thus making direct communication easier. In a case where the non-executor is close to the executor, the same screen may be displayed to the executor so that the executor and the non-executor can work together even if they are far from the apparatus 161. On the other hand, the user U163a is close to the apparatus but farther from the executor than the other non-executors. It may be safer not to allow such a user to perform any operations.

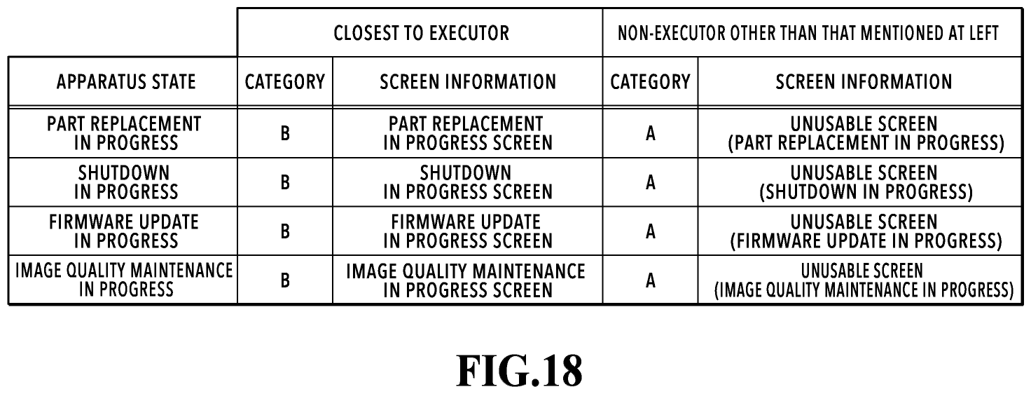

FIG. 18 shows an example of a correspondence list for switching the category depending on the distance from the executor. Here, FIG. 18 shows an example of switching the category depending on whether the user is closest to the executor. However, a reference value may be set for the distance from the executor, and the category may be switched depending on whether the reference value is exceeded.

Examples of the user information for determining the list to be applied include a device used, a user level, and the like. The display contents may be switched depending on whether the device used by the non-executor is a desktop PC, a tablet, or a smartphone. For a smartphone user, the device operation restrictions may be stricter than for users of other devices. The user level may be set according to the user's proficiency, and the display contents may be switched according to that information. For a high-level user, it is possible to always display the same contents as the executor. The user information used to determine the correspondence list to be applied may be in a format set by the user, or in a format in which the system analyzes the user's operation history to determine the optimal list.

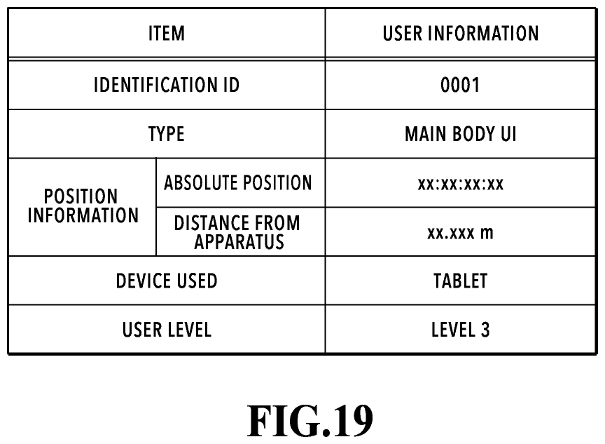

Alternatively, the correspondence list to be applied may be determined by combining plural pieces of user information, rather than determining the correspondence list to be applied from a single piece of user information. As long as the user information includes information on all items, for example, as shown in FIG. 19, plural items can be combined. Here, the identification ID, type, position information, device used, and user level are given as the user information. The type is information on the UI used, such as the main UI or remote UI. The absolute position of the position information is the position information itself obtained by a GPS or the like, and the distance from the apparatus 161 is the distance from the reference point of the apparatus 161. The device used may be a desktop, a tablet, a smartphone or the like. The user level indicates the user's level, for example, by a numerical value. In a case where the executor is the main body UI user but is far from the apparatus, the display contents can be switched more flexibly by combining plural pieces of user information, such as applying a corresponding list in which the main body UI is not dominant.

The user information described here is an example, and any other information that serves as an index to identify each user can be used as the user information for determining the list to be applied. The detailed contents of the list to be applied are also an example, and can be flexibly set in consideration of the method of use of the apparatus or the like. The contents displayed on the screen of the non-executor may be selected individually or collectively by the executor. Alternatively, in a case where the main body UI user is the executor, the main body UI user may individually or collectively select the contents displayed on the screen of the non-executor. On the other hand, the display contents may be selected by the non-executor and displayed in a case where the executor approves them.

### Other Embodiments

The present disclosure can also be implemented through processing including supplying a program for implementing one or more functions of the embodiments described above to a system or an apparatus by using a network or a storage medium, and reading and executing, by a computer of the system or the apparatus, the program. The computer includes one or more processors or circuits, and may include a network of a plurality of individual computers or a plurality of individual processors or circuits, to read and execute a computer-readable instruction.

The processor or circuit may include a central processing unit (CPU), a micro processing unit (MPU), a graphics processing unit (GPU), an application specific integrated circuit (ASIC), or a field-programmable gate array (FPGA). Moreover, the processor or circuit can include a digital signal processor (DSP), a data flow processor (DFP), or a neural processing unit (NPU).

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-084295, filed May 23, 2024, which is hereby incorporated by reference herein in its entirety.

What is claimed is:

1. A display control method for controlling display contents on a display device capable of displaying a screen related to an apparatus, comprising:
displaying a screen of a function using a first function control unit in the apparatus on a second display device operated by a second user different from a first user operating a first display device, based on an instruction from the second user; and
performing control so that a screen related to the apparatus displayed on the second display device is not transitioned to a screen related to the apparatus displayed on the first display device, in a case where a screen of a function that uses a second function control unit different from the first function control unit in the apparatus and requires ensuring safety is operated on the first display device, based on an instruction from the first user.

2. The display control method according to claim 1, wherein the function that requires ensuring safety is a function executed by the second function control unit.

3. The display control method according to claim 1, wherein the function that requires ensuring safety is a function that operates in a state where an interlock function used to maintain the safety of the apparatus is active.

4. The display control method according to claim 1, wherein, while a screen of the function that requires ensuring safety is operated on the first display device operated by the first user, a button for operating the function displayed on the second display device operated by the second user is displayed in a disabled state.

5. The display control method according to claim 1, wherein, the performing control includes transitioning a screen related to the apparatus displayed on the second display device to a predetermined screen, in a case where the screen of the function that uses the second function control unit in the apparatus and requires ensuring safety is operated on the first display device, based on an instruction from the first user.

6. The display control method according to claim 5, wherein, in the displaying, in a case where the second display device operated by the second user displays a screen for starting the function that requires ensuring the safety, the predetermined screen is a screen that displays a button for operating the function that requires ensuring safety in a disabled state.

7. The display control method according to claim 5, wherein, in the displaying, in a case where the second display device operated by the second user displays a screen for starting the function that requires ensuring the safety, the predetermined screen is a screen for a function that does not require ensuring the safety.

8. The display control method according to claim 1, further comprising:
obtaining an apparatus state of the apparatus;
determining whether there is a change in the apparatus state after execution of any of the functions of the apparatus by the first user; and
determining display contents to be displayed on the second display device operated by the second user, in a case where it is determined that there is a change in the apparatus state, according to the obtained apparatus state, information about a user using the first function control unit and the second function control unit, and information in which actions to be taken in a case of switching display contents to be displayed on the second display device operated by the second user are classified into a plurality of categories.

9. The display control method according to claim 8, further comprising:
determining whether a screen transition instruction is inputted, in a case where a function that uses the second function control unit and does not require ensuring safety is executed by the first user, a function using the first function control unit is executed by the second user, and the display contents displayed on the second display device are the same as those of the first display device operated by the first user, or in a case where a function that uses the second function control unit and requires ensuring safety is executed by the first user, and a function using the first function control unit is executed by the second user, wherein
the determining includes, in a case where it is determined that the screen transition instruction is inputted, determining the display contents to be displayed on the second display device, based on the obtained apparatus state, information about the user using the first function control unit and the second function control unit, and the information classified into the plurality of categories.

10. The display control method according to claim 9, wherein
the plurality of categories include a first category that is an action for automatically transitioning to the same display contents as the display contents displayed on the first display device, and
the determining includes determining to automatically transition to the same display contents as the display contents displayed on the first display device, in a case where the obtained apparatus state corresponds to the first category.

11. The display control method according to claim 9, wherein
the plurality of categories include a second category that is an action for automatically transitioning to display contents different from the display contents displayed on the first display device, and
the determining includes determining to automatically transition to the display contents different from the display contents displayed on the first display device, in a case where the obtained apparatus state corresponds to the second category.

12. The display control method according to claim 9, wherein the plurality of categories include a third category that is an action for manually transitioning to the same display contents as the display contents displayed on the first display device.

13. The display control method according to claim 9, wherein the plurality of categories include a fourth category that is an action for manually transitioning to display contents different from the display contents displayed on the first display device.

14. The display control method according to claim 8, wherein the information classified into the plurality of categories includes a list in which the apparatus state, any of the plurality of categories, and the display contents are associated with each other.

15. The display control method according to claim 14, further comprising:
obtaining information capable of identifying the first display device to which an instruction to transition to the obtained apparatus state is inputted, wherein
the determining includes determining the display contents further based on the information capable of identifying the first display device.

16. The display control method according to claim 15, wherein
the list includes a plurality of types of lists,
the method further comprising:
selecting a list to be applied from among the plurality of types of lists, according to the information capable of identifying the first display device, wherein
the determining is performed using the list selected in the selecting.

17. The display control method according to claim 16, wherein
the information capable of identifying the first display device includes information indicating a type of the first display device and a type of the second display device, and
the plurality of types of lists include a list with the type applied to the first display device directly connected to the apparatus and a list with the type applied to the second display device connected to the apparatus via a network.

18. The display control method according to claim 16, wherein
the information capable of identifying the first display device includes position information of the first display device, and
the plurality of types of lists include different lists according to a distance from a position where the apparatus is disposed.

19. The display control method according to claim 16, wherein
the information capable of identifying the first display device includes position information of the first display device, and
the plurality of types of lists include different lists according to a distance from the first display device to which the instruction to transition to the apparatus state is inputted.

20. A display control system comprising an apparatus and a display device capable of displaying a screen related to the apparatus, wherein
the display device includes:
a first display device operated by a first user; and
a second display device different from the first display device, which is operated by a second user different from the first user,
the apparatus includes one or more processors and/or circuitry which function as:
a first function control unit configured to execute a function that does not require ensuring safety;
a second function control unit different from the first function control unit, being configured to execute a function that requires ensuring the safety; and
a display control unit configured to display a screen of a function using the first function control unit in the apparatus on the second display device operated by the second user, based on an instruction from the second user, and perform control so that a screen related to the apparatus displayed on the second display device is not transitioned to a screen related to the apparatus displayed on the first display device, in a case where a screen of a function that uses a second function control unit in the apparatus and requires ensuring the safety is operated, based on an instruction from the first user.
